(19) United States
(12) Patent Application Publication
(10) Pub. No.: US 2026/0302925 A1
(43) Pub. Date: Oct. 1, 2026

(54) FORCED CONTINUOUS CURRENT MODE SINGLE-INDUCTOR MULTIPLE-OUTPUT POWER CONVERSION CIRCUIT AND CONTROL METHOD THEREOF

(71) Applicant: Richtek Technology Corporation, Zhubei City (TW)

(72) Inventors: Jian-Ming FU, Zhubei City (TW); Huan-Chien YANG, New Taipei City (TW)

(21) Appl. No.: 19/297,149

(22) Filed: Aug. 12, 2025

(30) Foreign Application Priority Data
Mar. 31, 2025 (TW) 114112307

(51) Int. Cl. H02M 1/088; H02M 1/44; H02M 3/158

(52) U.S. Cl. CPC H02M 1/088; H02M 1/44; H02M 3/158

(57) ABSTRACT

A power conversion circuit includes a high-side transistor, a low-side transistor, an inductor, a plurality of switches, and a control circuit. The high-side transistor provides a supply voltage to a switch node based on a high-side driving signal. The low-side transistor couples the switch node to the ground based on a low-side driving signal. the inductor is coupled to the switch node. An inductor current flows through the inductor, and the inductor current is continuous. The switches provide the inductor current to one of the output voltages based on the corresponding switch signal. The control circuit generates the high-side driving signal and the low-side driving signal based on the state of the output voltage that is powered.

### CROSS REFERENCE TO RELATED APPLICATIONS

This Application claims priority of Taiwan Patent Application No. 114112307, filed on Mar. 31, 2025, the entirety of which is incorporated by reference herein.

### BACKGROUND OF THE INVENTION

### Field of the Invention

The disclosure is generally related to a power conversion circuit and a control method thereof, and more particularly it is related to a forced continuous current mode (FCCM) single-inductor multiple-output (SIMO) power conversion circuit and a control method thereof.

### Description of the Related Art

Because automotive applications require wireless communication and switching power converters are prone to electromagnetic interference (EMI), switching power converters must be specially designed to prevent their switching frequency from interfering with other communication devices.

In addition, single-inductor multiple-output (SIMO) power converters are an effective way to reduce costs, but they also present challenges, such as crosstalk. Therefore, controlling the timing for powering different output voltages becomes a critical issue.

### BRIEF SUMMARY OF THE INVENTION

A single-inductor multi-output (SIMO) power conversion circuit operating in continuous current mode and a control method for powering different output voltages are provided herein. Electromagnetic interference (EMI) in other frequency bands is reduced by forcing the power conversion circuit to operate in continuous current mode. This aids in up-holding the communication quality of the surrounding communication devices. The control method proposed in the present invention effectively prevents mutual interference among different output voltages and evenly supplies power to each of the output voltages, thereby maintaining the stability of the output voltages. Although the SIMO power conversion circuit proposed in the present invention needs to switch among different output voltages to individually power each of the output voltages, it can still operate stably in continuous current mode under various conditions to reduce EMI. Therefore, the SIMO power conversion circuit and the control method thereof proposed in the present invention not only achieve the advantage of significantly reducing circuit cost, but also control the EMI generated by the inductor current within an acceptable range under the condition of maintaining the stability of each the output voltages.

In an embodiment, a power conversion circuit comprises a high-side transistor, a low-side transistor, an inductor, a plurality of switches, and a control circuit. The high-side transistor provides a supply voltage to a switch node based on a high-side driving signal. The low-side transistor couples the switch node to a ground based on a low-side driving signal. The inductor is coupled to the switch node, wherein an inductor current flows through the inductor. The switches provide the inductor current to one of the output voltages based on a corresponding switch signal. The control circuit generates the high-side driving signal and the low-side driving signal based on a status of one of the output voltages that is powered. The inductor current is continuous.

According to an embodiment of the present invention, the control circuit generates the high-side driving signal and the low-side driving signal based on a clock signal, so that the inductor current is continuous. The clock signal has a clock frequency. The clock frequency is a fixed value to reduce EMI other than the clock frequency.

According to an embodiment of the present invention, the power conversion circuit further comprises an adaptive output sequencer. The adaptive output sequencer determines an order in which the switches are turned on based on output power of the output voltages.

According to an embodiment of the present invention, the switches comprise a first switch and a second switch. The first switch generates a first output voltage using the inductor current based on a first switch signal being enabled. The second switch generates a second output voltage using the inductor current based on a second switch signal being enabled. The adaptive output sequencer determines the order in which the first switch and the second switch are turned on based on a status of the first output voltage and a status of the second output voltage.

According to an embodiment of the present invention, when the first switch is turned on, the control circuit generates the high-side driving signal and the low-side driving signal based on the status of the first output voltage. When the second switch is turned on, the control circuit generates the high-side driving signal and the low-side driving signal based on the status of the second output voltage.

According to an embodiment of the present invention, the power conversion circuit further comprises a first voltage-dividing circuit, a second voltage-dividing circuit, a first error amplifier, a second error amplifier, a third error amplifier, and a fourth error amplifier. The first voltage-dividing circuit divides the first output voltage to generate a first feedback voltage. The second voltage-dividing circuit divides the second output voltage to generate a second feedback voltage. The first error amplifier generates a first error signal based on a difference between the first feedback voltage and a first reference voltage. The second error amplifier generates a second error signal based on a difference between the second feedback voltage and a second reference voltage. The third error amplifier generates a first task signal based on the first error signal and a compensation signal. The fourth error amplifier generates a second task signal based on a difference between the second error signal and the compensation signal.

According to an embodiment of the present invention, when the first error signal exceeds the compensation signal and the adaptive output sequencer turns on the first switch, the control circuit turns on the high-side transistor based on the first task signal being enabled. When the first task signal is disabled, the control circuit turns off the high-side transistor and turns off the low-side transistor. When output power of the first output voltage increases to cause the output voltage to be less than the first reference voltage, the first task signal is enabled.

According to an embodiment of the present invention, the power conversion circuit further comprises a current detection circuit and an adding circuit. The current detection circuit is configured to detect the inductor current to generate a current detection signal. The adding circuit is configured to add the current detection signal to a sawtooth wave to generate the compensation signal.

According to an embodiment of the present invention, the adaptive output sequencer comprises a load determination circuit, a sorting memory, and a switching controller. The load determination circuit sequentially enables a first queue signal corresponding to the first output voltage and a second queue signal corresponding to the second output signal based on an order in which the first task signal and the second task signal are enabled. The sorting memory sequentially stores the first queue signal and the second queue signal based on an order in which the first queue signal and the second queue signal are enabled. The switching controller sequentially enables the first switch signal and/or the second signal corresponding to the first queue signal and/or the second queue signal stored in the sorting memory, so that the inductor current sequentially powers the first output voltage and the second output voltage during different clock cycles based on the order in which the first queue signal and the second queue signal are enabled. During any one clock cycle, the inductor current only powers one of the first output voltage and the second output voltage.

According to an embodiment of the present invention, the sorting memory sequentially stores the first queue signal and the second queue signal. During a first clock cycle, the switching controller enables the first switch signal based on the first queue signal stored in the sorting memory. When the first clock cycle ends, the switching controller deletes the first queue signal stored in the sorting memory and disables the first switch signal. During a second clock cycle, the switching controller enables the second switch signal based on the second queue signal stored in the sorting memory. The second clock cycle takes place after the first clock cycle. When the second clock cycle ends, the switching controller deletes the second queue signal stored in the second sorting memory.

According to an embodiment of the present invention, during the first clock cycle, the load determination circuit, based on the first task signal, stores the first queue signal in the sorting memory and arranges the first queue signal after the second queue signal. When the second clock cycle ends, the switching controller disables the second switch signal. During a third clock cycle, the switching controller enables the first switch signal. The third clock cycle takes place after the second clock cycle.

According to an embodiment of the present invention, when the third clock cycle ends, the sorting memory is empty so that the switching controller does not delete the first queue signal. During a fourth clock cycle, the switching controller continuously enables the first switch signal. The fourth clock cycle takes place after the third clock cycle.

In another embodiment, a control method for controlling a single-inductor multiple-output power conversion circuit to convert a supply voltage into a plurality of output voltages is provided. The control method comprises the following steps. The single-inductor multiple-output power conversion circuit is driven based on a clock signal. Whether or not to power any one of the output voltages is determined. When it is determined to power a number of output voltages, each of the number of output voltages is sequentially powered during an individual clock cycle. The clock signal has a clock frequency. The clock frequency is a fixed value.

According to an embodiment of the present invention, the control method further comprises the following steps. When it is determined not to power the output voltages, one of the output voltages is continuously powered.

According to an embodiment of the present invention, an inductor current of the single-inductor multiple-output power conversion circuit is continuous, so as to reduce EMI other than the clock frequency.

According to an embodiment of the present invention, during any clock cycle, the inductor current only powers one of the first output voltage and the second output voltage.

According to an embodiment of the present invention, the output voltages comprise a first output voltage, a second output voltage, and a third output voltage. When it is determined to power the first output voltage and the second output voltage, the first output voltage is powered during a first clock cycle. The second output voltage is powered during a second clock cycle. The second clock cycle takes place after the first clock cycle.

According to an embodiment of the present invention, during the second clock cycle, a further determination is made to sequentially power the second output voltage and the third output voltage. During a third clock cycle after the second clock cycle, the third output voltage is powered. During a fourth clock cycle after the third clock cycle, the second output voltage is powered.

According to an embodiment of the present invention, during the second clock cycle, it is determined not to power any one of the first output voltage, the second output voltage, and the third output voltage. After the second clock cycle, the second output voltage is continuously powered until it is determined to power any one of the first output voltage, the second output voltage, and the third output voltage.

According to an embodiment of the present invention, during the first clock cycle, periods of charging and discharging an inductor of the single-inductor multiple-output power conversion circuit is determined based on a status of the first output voltage. During the second clock cycle, the periods of charging and discharging the inductor of the single-inductor multiple-output power conversion circuit is determined based on a status of the second output voltage.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a schematic diagram of a power conversion circuit in accordance with an embodiment of the present invention;

FIG. 2 is a schematic diagram of a determination circuit in accordance with an embodiment of the present invention;

FIG. 3 is a schematic diagram of an adaptive output sequencer in accordance with an embodiment of the present invention;

FIG. 4 is a waveform diagram of a power conversion circuit in accordance with an implementation of the present invention;

FIG. 5 is a schematic diagram showing the operation of the adaptive output sequencer in accordance with an embodiment of the present invention;

FIG. 6 is a schematic diagram showing the operation of the adaptive output sequencer in accordance with another embodiment of the present invention; and

FIG. 7 is a flow chart of a control method in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

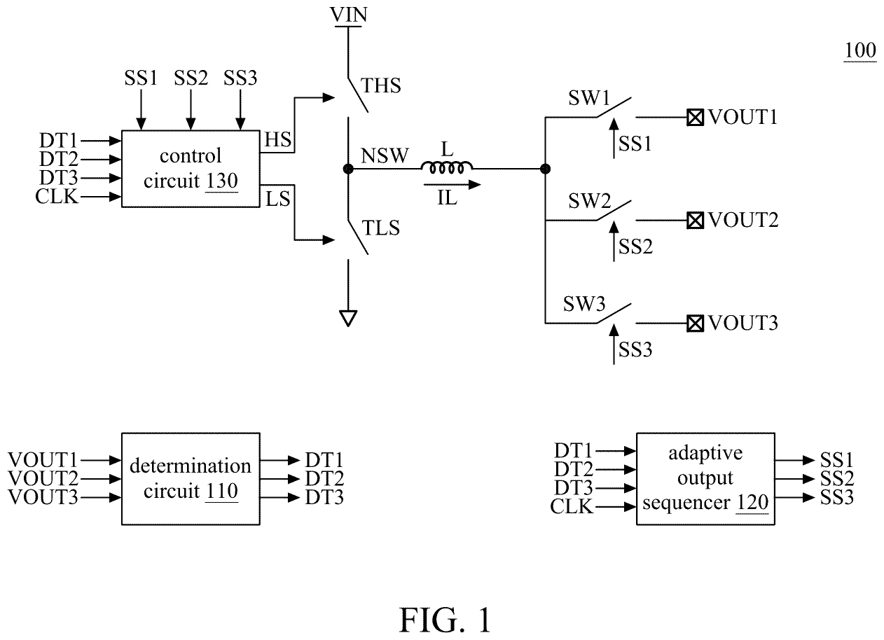

FIG. 1 is a schematic diagram of a power conversion circuit in accordance with an embodiment of the present invention. As shown in FIG. 1, the power conversion circuit 100 includes a high-side transistor THS, a low-side transistor TLS, an inductor L, a first switch SW1, a second switch SW2, and a third switch SW3. The high-side transistor THS provides an input voltage VIN to a switch node NSW based on a high-side driving signal HS. The low-side transistor TLS couples the switch node NSW to ground based on a low-side driving signal LS. The inductor L is coupled to the switch node NSW, and an inductor current IL flows through the inductor L.

The first switch SW1, the second switch SW2, and the third switch SW3 provide the inductor current IL to power a first output voltage VOUT1, a second output voltage VOUT2, and a third output voltage VOUT3, based on a first switching signal SS1, a second switching signal SS2, and a third switching signal SS3, respectively. According to some embodiments of the present invention, the power conversion circuit 100 is a single-inductor multi-output (SIMO) power conversion circuit.

According to some embodiments of the present invention, it is merely illustrated herein that the power conversion circuit 100 generates a first output voltage VOUT1, a second output voltage VOUT2, and a third output voltage VOUT3, but not intended to be limited thereto. According to some embodiments of the present invention, the power conversion circuit 100 only generates the first output voltage VOUT1 and the second output voltage VOUT2. According to other embodiments of the present invention, the power conversion circuit 100 may also generate any number of output voltages.

As shown in FIG. 1, the power conversion circuit 100 further includes a determination circuit 110, an adaptive output sequencer 120, and a control circuit 130. The determination circuit 110 is configured to determine whether any one of the first output voltage VOUT1, the second output voltage VOUT2, and the third output voltage VOUT3 needs to be powered, so as to enable the corresponding one of first task signal DT1, the second task signal DT2, and the third task signal DT3. According to an embodiment of the present invention, when the determination circuit 110 determines that the output power of any of the first output voltage VOUT1, the second output voltage VOUT2, and the third output voltage VOUT3 has increased, the corresponding task signal (i.e., the first task signal DT1, the second task signal DT2, or the third task signal DT3) is enabled.

According to another embodiment of the present invention, when the determination circuit 110 determines that the voltage value of any of the first output voltage VOUT1, the second output voltage VOUT2, and the third output voltage VOUT3 is lower than the corresponding reference voltage, the corresponding task signal (i.e., first task signal DT1, the second task signal DT2, and the third task signal DT3) is enabled. In other words, regardless of whether it is determined that the output voltage is lower than the reference voltage or that the output power of the output voltage has increased, it indicates that the output voltage needs to be powered.

According to some embodiments of the present invention, when the determination circuit 110 determines, based on the states of the first output voltage VOUT1, the second output voltage VOUT2, and the third output voltage VOUT3, that any one of the first output voltage VOUT1, the second output voltage VOUT2, and the third output voltage VOUT3 needs to be powered, the corresponding task signal (i.e., the first task signal DT1, the second task signal DT2, and the third task signal DT3) is enabled. The states of the first output voltage VOUT1, the second output voltage VOUT2, and the third output voltage VOUT3 include whether the voltage value is lower than a reference voltage and whether the output power is increased.

The adaptive output sequencer 120 sequentially enables the first switching signal SS1, the second switching signal SS2, and the third switching signal SS3 according to the order in which the first task signal DT1, the second task signal DT2, and the third task signal DT3 are enabled, so that the inductor current IL sequentially supplies power to the first output voltage VOUT1, the second output voltage VOUT2, and the third output voltage VOUT3 that need to be powered.

According to some embodiments of the present invention, the adaptive output sequencer 120 further enables the first switching signal SS1, the second switching signal SS2, and the third switching signal SS3 based on the clock signal CLK. In other words, the adaptive output sequencer 120 enables only one of the first switching signal SS1, the second switching signal SS2, and the third switching signal SS3 during one clock cycle of the clock signal CLK, and enables another of the first switching signal SS1, the second switching signal SS2, and the third switching signal SS3 during the next clock cycle.

According to some embodiments of the present invention, the determination circuit 110 generates the corresponding task signal (i.e., first task signal DT1, second task signal DT2, and third task signal DT3) based on the states of the first output voltage VOUT1, the second output voltage VOUT2, and the third output voltage VOUT3. This indicates that the adaptive output sequencer 120 determines the order in which the first switch signal SS1, the second switch signal SS2, and the third switch signal SS3 are turned on based on the states of the first output voltage VOUT1, the second output voltage VOUT2, and the third output voltage VOUT3.

The control circuit 130 generates the high-side driving signal HS and the low-side driving signal LS based on the first switch signal SS1, the second switch signal SS2, the third switch signal SS3, the first task signal DT1, the second task signal DT2, the third task signal DT3, and the clock signal CLK. Because the first switch signal SS1, the second switch signal SS2, and the third switch signal SS3 are sequentially enabled, the control circuit 130 generates the high-side driving signal HS and the low-side driving signal LS based on one of the first task signal DT1, the second task signal DT2, and the third task signal DT3 and the clock signal CLK.

More specifically, when the first switch signal SS1 is enabled, the control circuit 130 generates the high-side driving signal HS and the low-side driving signal LS based on the first task signal DT1 and the clock signal CLK. In other words, when the first switch SS1 is enabled, the control circuit 130, the high-side transistor THS, the low-side transistor TLS, the inductor L, and the first output voltage VOUT1 may be considered as a single-out-put-voltage conversion circuit, where the control circuit 130 drives the high-side transistor THS and the low-side transistor TLS based on the state of the first output voltage VOUT1.

According to other embodiments of the present invention, when the second switching signal SS2 is enabled, the control circuit 130 generates a high-side driving signal HS and a low-side driving signal LS based on the second task signal DT2 and the clock signal CLK. When the third switching signal SS3 is enabled, the control circuit 130 generates the high-side driving signal HS and a low-side driving signal LS based on the third task signal DT3 and the clock signal CLK. According to some embodiments of the present invention, the state of the first output voltage VOUT1 includes the voltage value of the first output voltage VOUT1 and the output power of the first output voltage VOUT1.

According to one embodiment of the present invention, the clock signal CLK has a clock frequency, where the clock frequency is a fixed value. In other words, the control circuit 130 drives the high-side transistor THS and the low-side transistor TLS at a fixed frequency, so that the inductor current IL is continuous, thereby avoiding affecting the communication quality of peripheral communication devices in other frequency bands. According to one embodiment of the present invention, the power conversion circuit 100 is a single-inductor multiple-output power conversion circuit in a forced continuous current mode (FCCM).

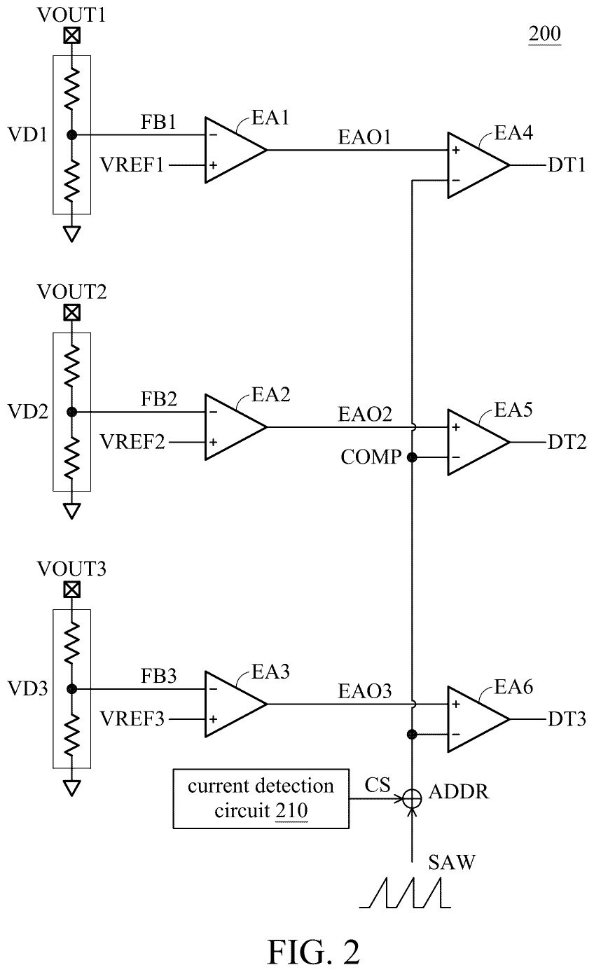

FIG. 2 is a schematic diagram of a determination circuit in accordance with an embodiment of the present invention. According to some embodiments of the present invention, the determination circuit 200 corresponds to the determination circuit 110 of FIG. 1. As shown in FIG. 2, the determination circuit 200 includes a first voltage-dividing circuit VD1, a second voltage-dividing circuit VD2, a third voltage-dividing circuit VD3, a first error amplifier EA1, a second error amplifier EA2, a third error amplifier EA3, a current detection circuit 210, an adder circuit ADDR, a fourth error amplifier EA4, a fifth error amplifier EA5, and a sixth error amplifier EA6.

The first voltage-dividing circuit VD1 divides the first output voltage VOUT1 to generate a first feedback voltage FB1. The second voltage-dividing circuit VD2 divides the second output voltage VOUT2 to generate a second feedback voltage FB2. The third voltage-dividing circuit VD3 divides the third output voltage VOUT3 to generate a third feedback voltage FB3.

The first error amplifier EA1 generates a first error signal EAO1 based on the difference between the first feedback voltage FB1 and the first reference voltage VREF1. According to one embodiment of the present invention, when the first feedback voltage FB1 is less than the first reference voltage VREF1, the first error signal EAO1 is in an enabled state. According to another embodiment of the present invention, when the first feedback voltage FB1 is not less than the first reference voltage VREF1, the first error signal EAO1 is in a disabled state.

The second error amplifier EA2 generates a second error signal EAO2 based on the difference between the second feedback voltage FB2 and the second reference voltage VREF2. According to one embodiment of the present invention, when the second feedback voltage FB2 is less than the second reference voltage VREF2, the second error signal EAO2 is in the enabled state. According to another embodiment of the present invention, when the second feedback voltage FB2 is not less than the second reference voltage VREF2, the second error signal EAO2 is in the disabled state.

The third error amplifier EA3 generates a third error signal EAO3 based on the difference between the third feedback voltage FB3 and the third reference voltage VREF3. According to an embodiment of the present invention, when the third feedback voltage FB3 is less than the third reference voltage VREF3, the third error signal EAO3 is in the enabled state. According to another embodiment of the present invention, when the third feedback voltage FB3 is not less than the third reference voltage VREF3, the third error signal EAO3 is in the disabled state.

The current detection circuit 210 is configured to detect the inductor current IL to generate a current detection signal CS. The adding circuit ADDR is configured to add the current detection signal CS to the sawtooth wave SAW to generate a compensation signal COMP.

The fourth error amplifier EA4 generates a first task signal DT1 based on the difference between the first error signal EAO1 and the compensation signal COMP. According to an embodiment of the present invention, when the first error signal EAO1 is not less than the compensation signal COMP, the first task signal DT1 is in the enabled state. According to another embodiment of the present invention, when the first error signal EAO1 is less than the compensation signal COMP, the first task signal DT1 is in the disabled state.

The fifth error amplifier EA5 generates the second task signal DT2 based on the difference between the second error signal EAO2 and the compensation signal COMP. According to an embodiment of the present invention, when the second error signal EAO2 is not less than the compensation signal COMP, the second task signal DT2 is in the enabled state. According to another embodiment of the present invention, when the second error signal EAO2 is less than the compensation signal COMP, the second task signal DT2 is in the disabled state.

The sixth error amplifier EA6 generates the third task signal DT3 based on the difference between the third error signal EAO3 and the compensation signal COMP. According to one embodiment of the present invention, when the third error signal EAO3 is not less than the compensation signal COMP, the third task signal DT3 is in the enabled state. According to another embodiment of the present invention, when the third error signal EAO3 is less than the compensation signal COMP, the third task signal DT3 is in the disabled state.

According to some embodiments of the present invention, the control circuit 130 of FIG. 1 determines the on-time of the high-side transistor THS based on one of the first task signal DT1, the second task signal DT2, and the third task signal DT3. According to other embodiments of the present invention, the compensation signal COMP may be a fixed voltage. In other words, when the compensation signal COMP is replaced by a fixed voltage, the on-time of the high-side transistor THS in FIG. 1 is constant. It is illustrated herein that the compensation signal COMP is the sum of the current detection signal CS and the sawtooth wave SAW, but is not intended to be limited thereto.

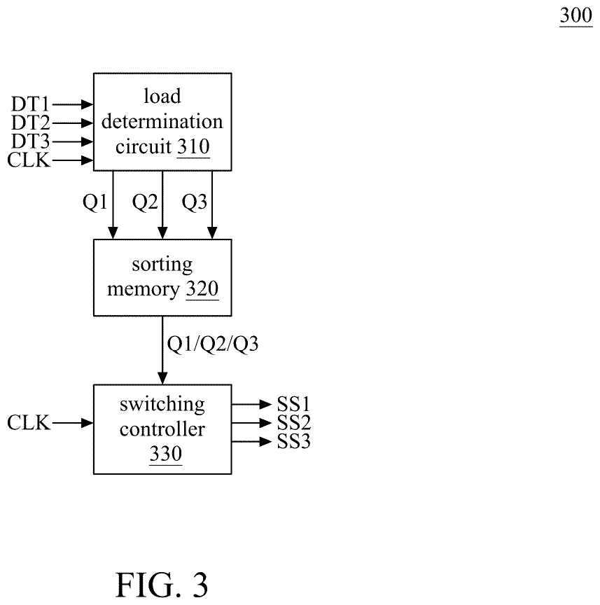

FIG. 3 is a schematic diagram of an adaptive output sequencer in accordance with an embodiment of the present invention. According to some embodiments of the present invention, the adaptive output sequencer 300 corresponds to the adaptive output sequencer 120 of FIG. 1. As shown in FIG. 3, the adaptive output sequencer 300 includes a load determination circuit 310, a sorting memory 320, and a switching controller 330.

The load determination circuit 310 enables the first queue signal Q1, the second queue signal Q2, and the third queue signal Q3 based on the order in which the first task signal DT1, the second task signal DT2, and the third task signal DT3 are enabled. The sorting memory 320 stores the first queue signal Q1, the second queue signal Q2, and the third queue signal Q3 in sequence based on the order in which the first queue signal Q1, the second queue signal Q2, and the third queue signal Q3 are enabled. The switching controller 330 enables the corresponding first switching signal SS1, second switching signal SS2, and third switching signal SS3 in sequence during different clock cycles of the clock signal CLK based on the order in which the first queue signal Q1, the second queue signal Q2, and the third queue signal Q3 are stored in the sorting memory 320, thereby supplying power to a corresponding one of the first output voltage VOUT1, the second output voltage VOUT2, and the third output voltage VOUT3.

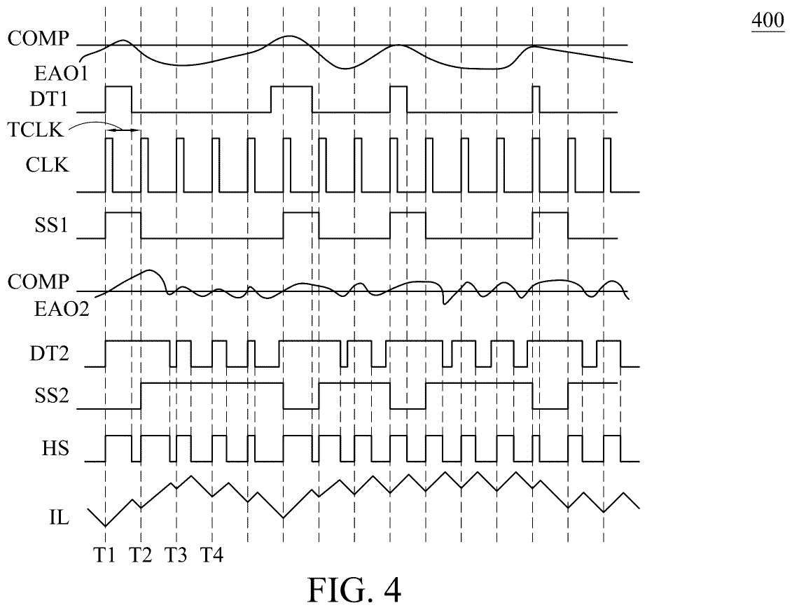

FIG. 4 is a waveform diagram of a power conversion circuit in accordance with an implementation of the present invention. The following description will be provided with reference to the power conversion circuit 100 of FIG. 1, the determination circuit 200 of FIG. 2, and the adaptive output sequencer 300 of FIG. 3 for a detailed explanation. According to some embodiments of the present invention, for simplicity of explanation, the waveform diagram 400 is illustrated herein as the power conversion circuit 100 only includes the first output voltage VOUT1 and the second output voltage VOUT2, but it is not intended to be limited thereto.

Furthermore, for simplicity of description, the compensation signal COMP is illustrated as a fixed voltage. However, in practice, the compensation signal COMP may be a ramp wave or a fixed voltage. According to some embodiments of the present invention, when the compensation signal COMP is a fixed voltage, the on-time of the high-side transistor THS in FIG. 1 is fixed.

As shown in FIG. 4, at the first timing point T1, since both the first error signal EAO1 and the second error signal EAO2 are not less than the compensation signal COMP, the first task signal DT1 and the second task signal DT2 are both enabled. In the embodiment of FIG. 4, the first switching signal SS1 is first enabled between the first timing point T1 and the second timing point T2, causing the inductor current IL to be provided to the first output voltage VOUT1. Furthermore, the duration of the high-side driving signal HS being enabled is equal to the duration of the first task signal DT1 being enabled. In other words, the control circuit 130 determines the on-time of the high-side transistor THS based on the pulse width of the first task signal DT1. As shown in FIG. 4, the period from the first timing point T1 to the second timing point T2 corresponds to the clock period TCLK of the clock signal CLK.

At the second timing point T2, the first switching signal SS1 is disabled and the second switching signal SS2 is enabled, so that the inductor current IL is provided to the second output voltage VOUT2 between the second timing point T2 and the third timing point T3, where the second timing point T2 to the third timing point T3 is another clock cycle TCLK. As shown in FIG. 4, the on-time of the high-side driving signal HS between the second timing point T2 and the third timing point T3 is equal to the duration that the second task signal DT2 is enabled.

As shown in FIG. 4, between the first timing point T1 and the third timing point T3, the inductor current IL continues to increase since the duration that the high-side driving signal HS is enabled is greater than the duration that the highs-side driving signal HS is disabled. According to an embodiment of the present invention, when the high-side driving signal HS is disabled, the low-side driving signal LS is enabled. In other words, when the high-side driving signal HS is enabled, the high-side transistor THS is turned on; when the high-side driving signal HS is disabled, the low-side transistor TLS is turned on.

At the third timing point T3, since the second task signal DT2 is enabled and the first task signal DT1 is disabled, the second switching signal SS2 is enabled between the third timing point T3 and the fourth timing point T4, so that the inductor current IL of FIG. 1 supplies power to the second output voltage VOUT2. In addition, the control circuit 130 of FIG. 1 drives the high-side transistor THS and the low-side transistor TLS based on the second task signal DT2. When the second error signal EAO2 is less than the compensation signal COMP, the control circuit 130 disables the high-side driving signal HS to turn off the high-side transistor THS and to turn on the low-side transistor TLS.

According to some embodiments of the present invention, when the high-side driving signal HS is enabled, the inductor current IL increases; when the high-side driving signal HS is disabled, the inductor current IL decreases. In other words, when the enable time of the high-side driving signal HS is greater than the disable time, the inductor current IL gradually increases; when the enable time of the high-side driving signal HS is less than the disable time, the inductor current IL gradually decreases.

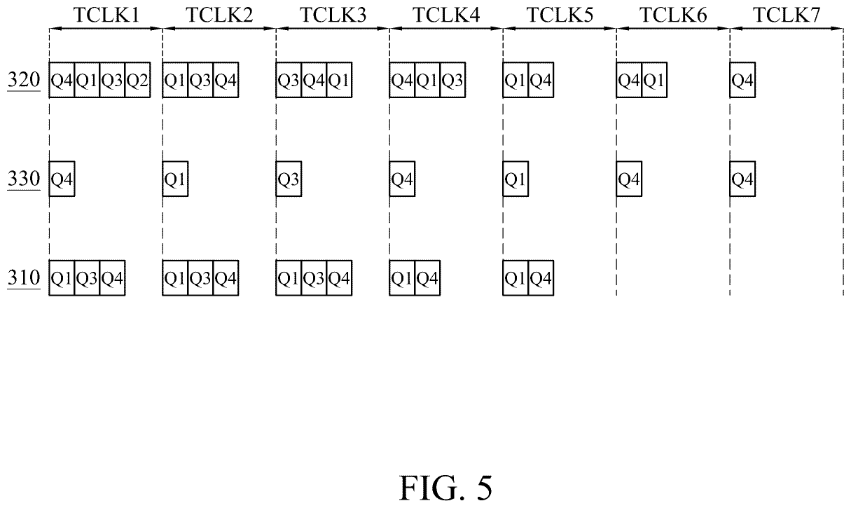

FIG. 5 is a schematic diagram showing the operation of the adaptive output sequencer in accordance with an embodiment of the present invention. The following description of FIG. 5 will be described in conjunction with the power conversion circuit 100 of FIG. 1 and the adaptive output sequencer 300 of FIG. 3 for a detailed explanation. FIG. 5 is illustrated with the power conversion circuit 100 of FIG. 1 having a first output voltage VOUT1, a second output voltage VOUT2, a third output voltage VOUT3, and a fourth output voltage (not shown in FIG. 1) as an example, but is not intended to be limited thereto.

As shown in FIG. 5, during the first clock cycle TCLK1, the fourth queue signal Q4, the first queue signal Q1, the third queue signal Q3, and the second queue signal Q2 are sequentially stored in the sequence memory 320. During the first clock cycle TCLK1, the switching controller 330 turns on the fourth switch (not shown in FIG. 1) based on the fourth queue signal Q4 and uses the inductor current IL to power the fourth output voltage (not shown in FIG. 1).

Furthermore, the load determination circuit 310 determines during the first clock cycle TCLK1 that the first output voltage VOUT1, the third output voltage VOUT3, and the fourth output voltage need to be powered, thereby enabling the first queue signal Q1, the third queue signal Q3, and the fourth queue signal Q4. Since the fourth queue signal Q4 is ranked first in the sorting memory 320 and the first queue signal Q1 and the third queue signal Q3 are ranked after the fourth queue signal Q4, the load determination circuit 310 deletes the second queue signal Q2 stored in the sorting memory 320 and ranks the fourth queue signal Q4 after the third queue signal Q3.

When the first clock cycle TCLK1 ends, the switching controller 330 deletes the fourth queue signal Q4, which is ranked first, from the sorting memory 320 and stops providing the inductor current IL to the fourth output voltage. During the second clock cycle TCLK2, the switching controller 330 turns on the first switch SW1 based on the first queue signal Q1, which is ranked first in the sorting memory 320, so that the inductor current IL is provided to the first output voltage VOUT1.

Furthermore, during the second clock cycle TCLK2, the load determination circuit 310 determines that the first output voltage VOUT1, the third output voltage VOUT3, and the fourth output voltage need to be powered, thereby enabling the first queue signal Q1, the third queue signal Q3, and the fourth queue signal Q4. Since the switching controller 330 just turns on the first switch SW1 based on the first queue signal Q1, and the third queue signal Q3 and the fourth queue signal Q4 are stored in the sorting memory 320, the load determination circuit 310 arranges the enabled first queue signal Q1 after the fourth queue signal Q4.

When the second clock cycle TCLK2 ends, the switching controller 330 deletes the first queue signal Q1 in the sorting memory 320 and disables the first switch signal SS1 to turn off the first switch SW1. Then, during the third clock cycle TCLK3, the switching controller 330 supplies power to the third output voltage VOUT3 based on the third queue signal Q3, which is ranked first. During the third clock cycle TCLK3, the load determination circuit 310 enables the first queue signal Q1, the third queue signal Q3, and the fourth queue signal Q4, and arranges the third queue signal Q3 after the first queue signal Q1.

During the fourth clock cycle TCLK4, the switching controller 330 provides the inductor current IL to the fourth output voltage based on the fourth queue signal Q4, which is ranked first. In addition, the load determination circuit 310 enables the first queue signal Q1 and the fourth queue signal Q4 during the fourth clock cycle TCLK4, deletes the third queue signal Q3, which is no longer needed, from the sorting memory 320, and arranges the fourth queue signal Q4 after the first queue signal Q1.

During the fifth clock cycle TCLK5, the switching controller 330 turns on the first switch SW1 based on the first queue signal Q1 ranked first, so that the inductor current IL is provided to the first output voltage VOUT1. In addition, the load determination circuit 310 enables the first queue signal Q1 and the fourth queue signal Q4 during the fifth clock cycle TCLK5, and arranges the first queue signal Q1 after the fourth queue signal Q4.

During the sixth clock cycle TCLK6, the switching controller 330 provides the inductor current IL to the fourth output voltage based on the fourth queue signal Q4, which is ranked first. Furthermore, during the sixth clock cycle TCLK6, the load determination circuit 310 does not enable any of the first queue signal Q1, the second queue signal Q2, the third queue signal Q3, and the fourth queue signal Q4. Therefore, the load determination circuit 310 deletes the first queue signal Q1 from the sorting memory 320.

Since the load determination circuit 310 does not enable any queue signal during the sixth clock cycle TCLK6, the switching controller 330 does not delete the fourth queue signal Q4 stored in the sorting memory 320 at the end of the sixth clock cycle TCLK6 and continues to supply power to the fourth output voltage during the seventh clock cycle TCLK7.

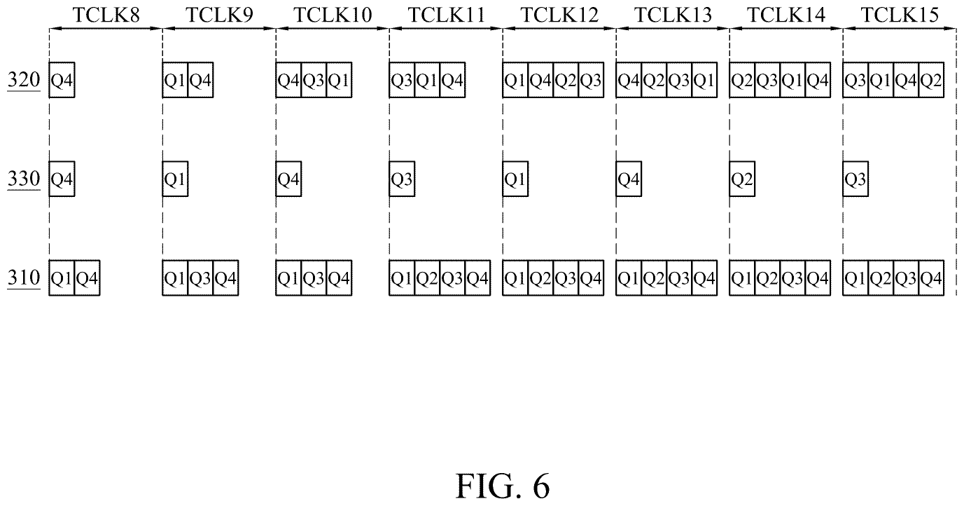

FIG. 6 is a schematic diagram showing the operation of the adaptive output sequencer in accordance with another embodiment of the present invention. The following description of FIG. 6 will be described in conjunction with the power conversion circuit 100 of FIG. 1 and the adaptive output sequencer 300 of FIG. 3 for a detailed explanation.

As shown in FIG. 6, during the eighth clock cycle TCLK8, the switching controller 330 turns on the fourth switch based on the fourth queue signal Q4 being enabled in the sorting memory 320, to supply power to the fourth output voltage. Furthermore, the load determination circuit 310 enables the first queue signal Q1 and the fourth queue signal Q4 during the eighth clock cycle TCLK8 and sequentially stores the first queue signal Q1 and the fourth queue signal Q4 in the sorting memory 320. According to an embodiment of the present invention, since the fourth queue signal Q4 has been ranked first during the eighth clock cycle TCLK8, when the load determination circuit 310 enables the fourth queue signal Q4 again, the fourth queue signal Q4 must be arranged at the last position to facilitate evenly supplying power to the output voltages that need to be powered.

During the ninth clock cycle TCLK9, the switching controller 330 turns on the first switch SW1 based on the first queue signal Q1 ranked first to supply power to the first output voltage VOUT1. Furthermore, the load determination circuit 310 enables the first queue signal Q1, the third queue signal Q3, and the fourth queue signal Q4. Since the switching controller 330 is currently supplying power to the first output voltage VOUT1, and the fourth queue signal Q4 has been already arranged after the first queue signal Q1, the third queue signal Q3 is arranged after the fourth queue signal Q4, and the first queue signal Q1 is arranged after the fourth queue signal Q4.

During the tenth clock cycle TCLK10, the switching controller 330 turns on the fourth switch based on the fourth queue signal Q4, allowing the inductor current IL to power the fourth output voltage. Furthermore, the load determination circuit 310 enables the first queue signal Q1, the third queue signal Q3, and the fourth queue signal Q4 during the tenth clock cycle TCLK10. Since the third queue signal Q3 and the first queue signal Q1 have been sequentially arranged after the fourth queue signal Q4, which is ranked first, the load determination circuit 310 arranges the fourth queue signal Q4 after the first queue signal Q1.

During the eleventh clock cycle TCLK11, the inductor current IL is provided to the third output voltage VOUT3, and the load determination circuit 310 enables the first queue signal Q1, the second queue signal Q2, the third queue signal Q3, and the fourth queue signal Q4. Since the third queue signal Q3 is ranked first in the sorting memory 320, and the first queue signal Q1 and the fourth queue signal Q4 have been sequentially arranged after the third queue signal Q3, the load determination circuit 310 arranges the second queue signal Q2 after the fourth queue signal Q4, and the third queue signal Q3 after the second queue signal Q2.

During the twelfth clock cycle TCLK12, the inductor current IL is provided to the first output voltage VOUT1, and the load determination circuit 310 enables the first queue signal Q1, the second queue signal Q2, the third queue signal Q3, and the fourth queue signal Q4. Since all the queue signals have been stored in the sorting memory 320 and the first queue signal Q1 is ranked first, the load determination circuit 310 arranges the first queue signal Q1 after the third queue signal Q3.

During the thirteenth clock cycle TCLK13, the inductor current IL is provided to the fourth output voltage, and the load determination circuit 310 enables the first queue signal Q1, the second queue signal Q2, the third queue signal Q3, and the fourth queue signal Q4. Since all the queue signals are stored in the sorting memory 320 and the fourth queue signal Q4 is ranked first, the load determination circuit 310 arranges the fourth queue signal Q4 after the first queue signal Q1.

During the fourteenth clock cycle TCLK14, the inductor current IL is provided to the second output voltage VOUT2, and the load determination circuit 310 enables the first queue signal Q1, the second queue signal Q2, the third queue signal Q3, and the fourth queue signal Q4. Since all the queue signals have been stored in the sorting memory 320, and the second queue signal Q2 is ranked first, the load determination circuit 310 arranges the second queue signal Q2 at the last position.

During the fifteenth clock cycle TCLK15, the inductor current IL is provided to the third output voltage VOUT3, and the load determination circuit 310 enables the first queue signal Q1, the second queue signal Q2, the third queue signal Q3, and the fourth queue signal Q4. Since all the queue signals have been stored in the sorting memory 320, and the third queue signal Q3 is ranked first, the load determination circuit 310 arranges the third queue signal Q3 at the last position.

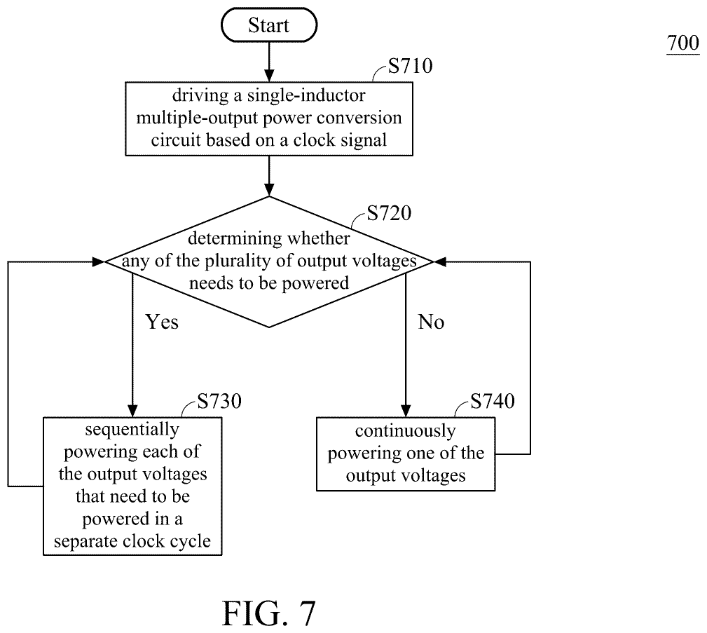

FIG. 7 is a flow chart of a control method in accordance with an embodiment of the present invention. The following description of the control method 700 of FIG. 7 will be provided in conjunction with the power conversion circuit 100 of FIG. 1, the determination circuit 200 of FIG. 2, and the adaptive output sequencer 300 of FIG. 3 for a detailed explanation.

As shown in FIG. 7, a single-inductor multiple-output power conversion circuit is driven based on the clock signal CLK (Step S710). According to some embodiments of the present invention, the power conversion circuit 100 of FIG. 1 is a single-inductor multiple-output power conversion circuit. According to one embodiment of the present invention, the clock signal CLK has a clock frequency, where the clock frequency is a constant value. According to some embodiments of the present invention, the power conversion circuit 100 of FIG. 1 is a forced continuous current mode power conversion circuit.

Next, whether any of the plurality of output voltages needs to be powered or not is determined (Step S720). According to one embodiment of the present invention, as shown in FIG. 2, a determination circuit 200 determines whether an output voltage is lower than a corresponding reference voltage to enable a corresponding task signal, and drives a high-side transistor THS and a low-side transistor TLS based on the task signal being enabled to supply power to the output voltage. According to another embodiment of the present invention, since output power of an output voltage too high may cause the output voltage to drop below the corresponding reference voltage, it is able to determine whether output power of an output voltage is too high to supply power to the output voltage. In other words, the determination circuit 200 determines whether to power any of the output voltages based on the status of the corresponding output voltages.

When Step S720 is determined to be yes, each of the output voltages that need to be powered is powered in sequence in a separate clock cycle (Step S730). After Step S730 is completed, the process returns to Step S720. In the embodiments of FIG. 4, FIG. 5, and FIG. 6, the output voltages that need to be powered are powered one by one in sequence in different clock cycles. In addition, only one output voltage is powered in a single clock cycle, and the on-time of the high-side transistor THS is controlled according to the output voltage being powered.

When Step S720 is determined to be no, one of the plurality of output voltages is continuously powered (Step S740). As shown in the sixth clock cycle TCLK6 and the seventh clock cycle TCLK7 in the embodiment of FIG. 4, since the load determination circuit 310 determines that no output voltage needs to be powered during the sixth clock cycle TCLK6, the switching controller 330 continues to power the fourth output voltage that was the last one to be powered during the seventh clock cycle TCLK7.

A single-inductor multi-output (SIMO) power conversion circuit operating in continuous current mode and a control method for powering different output voltages are provided herein. Electromagnetic interference (EMI) in other frequency bands is reduced by forcing the power conversion circuit to operate in continuous current mode. This aids in up-holding the communication quality of the surrounding communication devices. The control method proposed in the present invention effectively prevents mutual interference among different output voltages and evenly supplies power to each of the output voltages, thereby maintaining the stability of the output voltages. Although the SIMO power conversion circuit proposed in the present invention needs to switch among different output voltages to individually power each of the output voltages, it can still operate stably in continuous current mode under various conditions to reduce EMI. Therefore, the SIMO power conversion circuit and the control method thereof proposed in the present invention not only achieve the advantage of significantly reducing circuit cost, but also control the EMI generated by the inductor current within an acceptable range under the condition of maintaining the stability of each the output voltages.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit, comprising:
a high-side transistor, providing a supply voltage to a switch node based on a high-side driving signal;
a low-side transistor, coupling the switch node to a ground based on a low-side driving signal;
an inductor, coupled to the switch node, wherein an inductor current flows through the inductor;
a plurality of switches, providing the inductor current to one of the output voltages based on a corresponding one of a plurality of switch signals; and
a control circuit, generating the high-side driving signal and the low-side driving signal based on a status of one of the output voltages that is powered;
wherein the inductor current is continuous.

2. The power conversion circuit as claimed in claim 1, wherein the control circuit generates the high-side driving signal and the low-side driving signal based on a clock signal, so that the inductor current is continuous;
wherein the clock signal has a clock frequency;
wherein the clock frequency is a fixed value to reduce EMI other than the clock frequency.

3. The power conversion circuit as claimed in claim 1, further comprising:
an adaptive output sequencer, determining an order in which the switches are turned on based on output power of the output voltages.

4. The power conversion circuit as claimed in claim 3, wherein the switches comprise:
a first switch, generating a first output voltage using the inductor current based on a first switch signal being enabled; and
a second switch, generating a second output voltage using the inductor current based on a second switch signal being enabled;
wherein the adaptive output sequencer determines the order in which the first switch and the second switch are turned on based on a status of the first output voltage and a status of the second output voltage.

5. The power conversion circuit as claimed in claim 4, wherein when the first switch is turned on, the control circuit generates the high-side driving signal and the low-side driving signal based on the status of the first output voltage;
wherein when the second switch is turned on, the control circuit generates the high-side driving signal and the low-side driving signal based on the status of the second output voltage.

6. The power conversion circuit as claimed in claim 4, further comprising:
a first voltage-dividing circuit, dividing the first output voltage to generate a first feedback voltage;
a second voltage-dividing circuit, dividing the second output voltage to generate a second feedback voltage;
a first error amplifier, generating a first error signal based on a difference between the first feedback voltage and a first reference voltage;
a second error amplifier, generating a second error signal based on a difference between the second feedback voltage and a second reference voltage;
a third error amplifier, generating a first task signal based on the first error signal and a compensation signal; and
a fourth error amplifier, generating a second task signal based on a difference between the second error signal and the compensation signal.

7. The power conversion circuit as claimed in claim 6, wherein when the first error signal exceeds the compensation signal and the adaptive output sequencer turns on the first switch, the control circuit turns on the high-side transistor based on the first task signal being enabled;
wherein when the first task signal is disabled, the control circuit turns off the high-side transistor and turns off the low-side transistor;
wherein when output power of the first output voltage increases to cause the output voltage to be less than the first reference voltage, the first task signal is enabled.

8. The power conversion circuit as claimed in claim 6, further comprising:
a current detection circuit, configured to detect the inductor current to generate a current detection signal; and
an adding circuit, configured to add the current detection signal to a sawtooth wave to generate the compensation signal.

9. The power conversion circuit as claimed in claim 6, wherein the adaptive output sequencer comprises:
a load determination circuit, sequentially enabling a first queue signal corresponding to the first output voltage and a second queue signal corresponding to the second output signal based on an order in which the first task signal and the second task signal are enabled;
a sorting memory, sequentially storing the first queue signal and the second queue signal based on an order in which the first queue signal and the second queue signal are enabled; and
a switching controller, sequentially enabling the first switch signal and/or the second signal corresponding to the first queue signal and/or the second queue signal stored in the sorting memory, so that the inductor current sequentially powers the first output voltage and the second output voltage during different clock cycles based on the order in which the first queue signal and the second queue signal are enabled;
wherein during any one clock cycle, the inductor current only powers one of the first output voltage and the second output voltage.

10. The power conversion circuit as claimed in claim 9, wherein the sorting memory sequentially stores the first queue signal and the second queue signal;
wherein during a first clock cycle, the switching controller enables the first switch signal based on the first queue signal stored in the sorting memory;
wherein when the first clock cycle ends, the switching controller deletes the first queue signal stored in the sorting memory and disables the first switch signal;
wherein during a second clock cycle after the first clock cycle, the switching controller enables the second switch signal based on the second queue signal stored in the sorting memory;
wherein when the second clock cycle ends, the switching controller deletes the second queue signal stored in the second sorting memory.

11. The power conversion circuit as claimed in claim 10, wherein during the first clock cycle, the load determination circuit, based on the first task signal, stores the first queue signal in the sorting memory and arranges the first queue signal after the second queue signal;
wherein when the second clock cycle ends, the switching controller disables the second switch signal;
wherein during a third clock cycle after the second clock cycle, the switching controller enables the first switch signal.

12. The power conversion circuit as claimed in claim 11, wherein when the third clock cycle ends, the sorting memory is empty so that the switching controller does not delete the first queue signal;
wherein during a fourth clock cycle after the third clock cycle, the switching controller continuously enables the first switch signal.

13. A control method for controlling a single-inductor multiple-output power conversion circuit to convert a supply voltage into a plurality of output voltages, comprising:
driving the single-inductor multiple-output power conversion circuit based on a clock signal;
determining whether to power any one of the output voltages; and
when it is determined to power a number of output voltages, sequentially powering each of the number of output voltages during an individual clock cycle;
wherein the clock signal has a clock frequency;
wherein the clock frequency is a fixed value.

14. The control method as claimed in claim 13, further comprising:
when it is determined not to power the output voltages, continuously powering one of the output voltages.

15. The control method as claimed in claim 13, wherein an inductor current of the single-inductor multiple-output power conversion circuit is continuous, so as to reduce EMI other than the clock frequency.

16. The control method as claimed in claim 13, wherein during any clock cycle, the inductor current only powers one of the first output voltage and the second output voltage.

17. The control method as claimed in claim 13, wherein the output voltages comprise a first output voltage, a second output voltage, and a third output voltage;
wherein when it is determined to power the first output voltage and the second output voltage, the first output voltage is powered during a first clock cycle;
wherein the second output voltage is powered during a second clock cycle after the first clock cycle.

18. The control method as claimed in claim 17, wherein during the second clock cycle, it is further determined to sequentially power the second output voltage and the third output voltage;
wherein during a third clock cycle after the second clock cycle, the third output voltage is powered;
wherein during a fourth clock cycle after the third clock cycle, the second output voltage is powered.

19. The control method as claimed in claim 17, wherein during the second clock cycle, it is determined not to power any one of the first output voltage, the second output voltage, and the third output voltage;
wherein after the second clock cycle, the second output voltage is continuously powered until it is determined to power any one of the first output voltage, the second output voltage, and the third output voltage.

20. The control method as claimed in claim 17, wherein during the first clock cycle, periods of charging and discharging an inductor of the single-inductor multiple-output power conversion circuit is determined based on a status of the first output voltage;
wherein during the second clock cycle, the periods of charging and discharging the inductor of the single-inductor multiple-output power conversion circuit is determined based on a status of the second output voltage.
